(19) United States
(12) Patent Application Publication
(10) Pub. No.: US 2021/0381486 A1
(43) Pub. Date: Dec. 9, 2021

(54) VERTICAL AXIS WIND TURBINE

(71) Applicant: Ignacio JUAREZ, Austin, TX (US)

(72) Inventor: Ignacio JUAREZ, Austin, TX (US)

(21) Appl. No.: 17/283,264

(22) PCT Filed: Oct. 8, 2019
(86) PCT No.: PCT/US2019/055190

§ 371 Date: Apr. 7, 2021

Related U.S. Application Data
(60) Provisional application No. 62/742,865, filed on Oct. 8, 2018.

(51) Int. Cl. F03D 3/06; F03D 3/00

(52) U.S. Cl. CPC F03D 3/061; F03D 3/005; F03D 3/064; F05B 2250/71; F05B 2240/214; F05B 2250/12; F05B 2240/305

(57) ABSTRACT

The present device is a vertically oriented wind turbine blade having a rectangular simple curvilinear shaped blade, which includes a top edge, a bottom edge, an outer edge, an inner edge, an inner surface and an outer surface. The blade is formed using extrusion to approximate a uncompleted airfoil shape from the inner edge to the outer edge (relative to the turbine center or hub). The angle of attack, the solidity and the arms angle are designed to improve performance at low wind speeds.

### CROSS REFERENCE TO RELATED APPLICATIONS

This application claims the benefit of U.S. Provisional Patent Application No. 62/742,865, filed Oct. 8, 2018. This application may be related to U.S. patent application Ser. No. 16/083,157, filed Sep. 7, 2018, which claims priority to International Application No. PCT/US2017/021373, filed Sep. 8, 2017, which claims the benefit of U.S. Provisional Patent Application No. 62/305,460, filed Mar. 8, 2016, the entire disclosures of which are hereby incorporated by reference.

### INCORPORATION BY REFERENCE

All publications and patent applications mentioned in this specification are herein incorporated by reference to the same extent as if each individual publication or patent application was specifically and individually indicated to be incorporated by reference.

### FIELD

The present invention relates to wind turbines, in particular, to wind turbine blade and assembly technology.

### BACKGROUND

Historically numerous wind turbines have been designed and deployed using various designs. The major drawback with all of these designs is the complexity used in order to create the wind turbine, the design average wind condition and the cost involved with manufacturing and deployment of the wind turbines in the field.

Currently many wind turbines require complex mechanical devices in order to ensure that the turbine is oriented in the correct direction. One of the advantages of the current design is that regardless of the direction of the wind the wind turbine will effectively produce power.

### SUMMARY

In one aspect, embodiments of a blade for use in a wind turbine are provided. The blade comprises a cross-sectional shape comprising a portion of an airfoil, the airfoil having an upper surface that extends past the lower surface, creating a gap between the upper and lower surfaces, wherein the blade comprises a leading edge comprising a curved portion of the blade positioned away from an end of the upper and lower surface, and a trailing edge comprising an inner portion of an end of the upper surface.

In some embodiments, the blade comprises an extruded curved section and a second section. The angle of attack can be about 2-10 degrees. In some embodiments, an angle between the upper surface and the lower surface is about 15-30°. The length from the top edge to the bottom edge can be about 30-6000 cm. In some embodiments, the leading edge of the blade is curved towards the center of the turbine. The blade can comprise a rectangular shaped slat shaped into a curve and mounted to place the slat proximate to a leading edge of the blade. In some embodiments, an angle between the slat and the blade is about 0-12 degrees. The slat can comprise a sheet with at least three bends. In some embodiments, the blade comprises a rectangular shaped flap mounted at a trailing edge of the blade. The blade can comprise at least one of steel, aluminum, carbon fiber, fiber glass, or plastic. In some embodiments, the blade comprises a winglet along an upper edge of the blade and extending from the trailing edge to the leading edge.

In some embodiments, a wind turbine including at least one of the turbine blades described herein is provided. The blade can be mounted to a vertical rotor shaft with at least one transversely oriented strut such that an approximately curvilinear portion proximate to the outer edge defines the outer diameter of the turbine and the blade revolves about the rotor shaft. In some embodiments, the rotor shaft is connected to a generator. The generator can be a radial flux generator or an axial flux generator.

In some embodiments, the blade comprises one or more curves extending from the top edge to the bottom edge.

A turbine including a blade described herein can be mounted to a vertical rotor shaft with at least one transversely oriented strut such that the leading edge defines the outer diameter of the turbine and the blade revolves about the rotor shaft. In some embodiments, a turbine having a blade as described herein can have a solidity of about 0.2-1.

A wind turbine including the wind turbine blade of any of the above claims can have three blades and slats arranged about a central vertical axis wherein each of the slats are arranged relative to each of the blades to provide a vertical turbine that generates power using drag force operation in a first range of wind speeds and generates power using lift force operation in a second range of wind speeds. In some embodiments, the first range of wind speeds is about 0.5 MPH (0.22 m/s) to about 8 MPH (3.6 m/s). In some embodiments, the second range of wind speeds is about 8 MPH (3.6 m/s) to about 130 MPH (58.1 m/s).

A length of the blade from an upper edge to the lower edge is from about 15 inches (0.4 m) to about 20 feet (6.1 m). The blade can have a thickness of about 0.5 mm to 15 mm. In some embodiments, the blade comprises a flap attached to a blade inner surface or a blade outer surface to position the flap in relation to the trailing edge of the blade, the flap comprising a leading edge and a trailing edge. The flat trailing edge can be directed towards or away from the trailing edge of the blade.

A method producing a wind turbine blade comprising a blade as described herein can comprise extruding a portion of the blade comprising the leading edge of the blade and attaching the portion to a sheet of material comprising the trailing edge of the blade. In some embodiments, the method comprises assembling the vertical wind turbine blade with other components to form a vertical wind turbine. Assembling can comprise connecting the components. In some embodiments, an angle between the arms and the turbine middle horizontal point is between 15 to 35 degrees.

### BRIEF DESCRIPTION OF THE DRAWINGS

FIGS. 1A-1E illustrates an embodiment of a wind turbine blade.

FIG. 1F shows an embodiment of two sheets of material used to form a wind turbine blade.

FIG. 1G depicts an embodiment of a wind turbine.

FIG. 1H shows an extruded profile of the turbine.

FIG. 1I shows an uncompleted airfoil of the turbine using an extruded profile and a sheet of metal.

FIG. 2 illustrates an embodiment of a profile of a wind turbine blade and a slat.

FIG. 3 shows an embodiment of a profile of a wind turbine blade and a flap.

FIG. 4 depicts an embodiment of a profile of a wind turbine blade with a slat and a flap.

FIG. 5 illustrates another embodiment of a profile of a wind turbine blade.

FIG. 6 shows another embodiment of a profile of a wind turbine blade.

FIGS. 7A-7B depict an embodiment of a profile of a wind turbine blade comprising two sheets of material.

FIG. 8 illustrates an embodiment of a bridge used to fix a slat to a blade.

FIG. 9 shows an embodiment of a bridge used to fix a flap to a blade.

FIGS. 10A-10B depict an embodiment of a blade fixed to a slat using one or more bridges.

FIG. 11 illustrates an embodiment of a blade fixed to a flap using bridges.

FIGS. 12-14 show various views of an embodiment of a turbine arm.

FIG. 15A depicts an embodiment of a connection between a blade and a turbine arm.

FIG. 15B Shows the connection of the extruded arms to the turbine blade.

FIG. 16 illustrates an embodiment of turbine arms mounted to a blade.

FIG. 17 shows an embodiment of a connection between a turbine arm and a generator.

FIG. 18 depicts a top down view of an embodiment of a turbine.

FIG. 19 illustrates a perspective view of an embodiment of a turbine.

FIGS. 20A-20C show side views of an embodiment of a turbine.

FIGS. 21A-21B illustrate views of an embodiment of a turbine.

FIGS. 22A-22B depict views of an embodiment of a turbine.

FIGS. 23A-23B illustrate views of an embodiment of a turbine.

FIG. 24 shows a perspective view of an embodiment of a turbine.

FIG. 25 depicts a perspective view of an embodiment of a turbine.

FIGS. 26A-26D illustrate schematic views of a packed turbine.

FIG. 27 shows an exploded view of the components of an embodiment of a turbine.

FIG. 28 depicts a graphic showing aerodynamic forces on a wind turbine blade.

FIG. 29 illustrates a graph showing angle of attack for various wind turbine blade configurations.

FIG. 30 Shows a graph explaining the effect of different solidity blade in the turbine performance

### DETAILED DESCRIPTION

This application provides various embodiments of vertical wind turbine blades. The turbine can have mirror arms configuration through the horizontal axis, where the blades are fixed. The blades can be mounted concentrically in a vertical axis. The number of blades and arms in each turbine can vary. Each blade is designed as an uncompleted airfoil, generating an outer side that produces lift at high wind speeds and an inner side that produces starting torque at low wind speeds. In some embodiments, a turbine configuration will include a slat that can increase the effective angle of each blade, increasing the torque and power of the turbine at low wind speeds. In still other configurations, a blade with a slat and a flap can also generate high drag at high wind speeds, braking the turbine itself and limiting working RPMs. The use, number, size and angle of the slats and/or flaps may vary, depending on the average wind speed in the area or the desired power output. Blades, slats, flaps and arms can be manufactured by bending, press, extrude, thermoform, injected, 3D printed or milled in different materials like aluminum, plastic, wood, steel or composites.

Traditionally, such vertical wind turbines utilize blades shaped as airfoils. Such airfoils are generally produced using the same manufacturing techniques as airplane wings or propellers. Such a process is very expensive and time consuming as such components require very precise specifications to enable their function and to ensure safety. Additionally, airfoils generally comprise complex internal structure, making manufacturing of the precise configuration more difficult and making shipping very expensive as the structure can be very large and heavy. The turbine blades disclosed herein differ in that they can use a simpler manufacturing process, comprising, for example, extruding a material, to approximate the shape of an airfoil. Additionally, the turbine blades disclosed herein approximate the outer shape of an airfoil, but do not include any complex internal structure. The simpler manufacturing process and minimal internal structure can produce a shape sufficient to extract a significant amount of wind power while minimizing manufacturing and shipping costs.

The devices and methods described herein are scalable and can be used to produce vertical wind turbine blades of varying sizes. An extruded profile of the blade can be cut into an specific length and use to manufacture a vertical wind turbine blade of a desired size. The size can be selected based on the application of the resulting wind turbine.

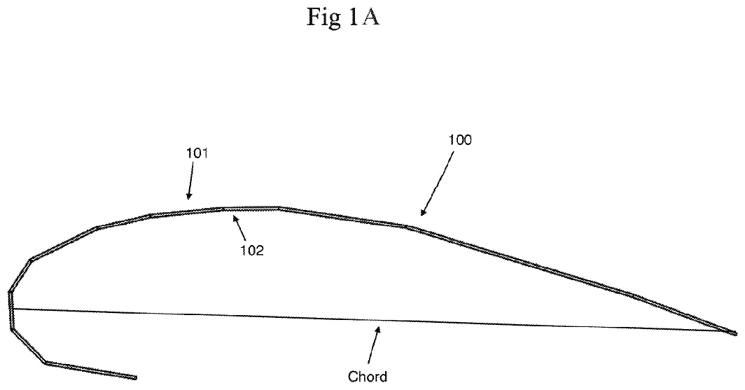

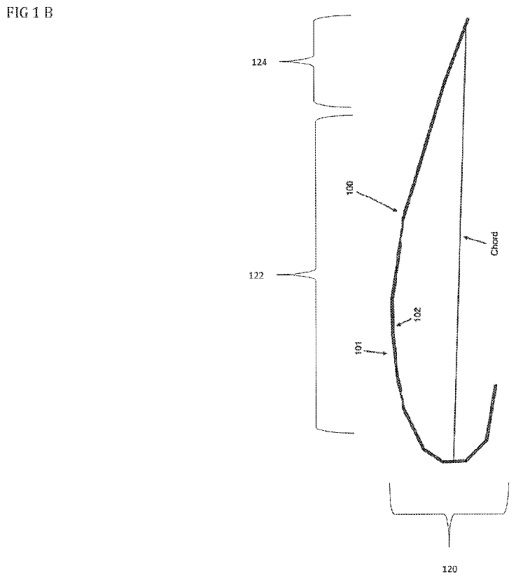

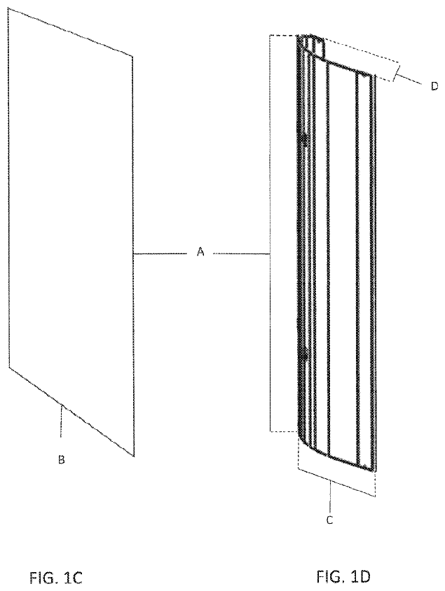

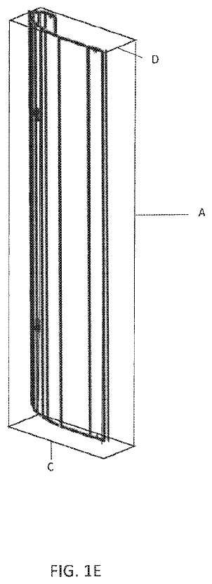

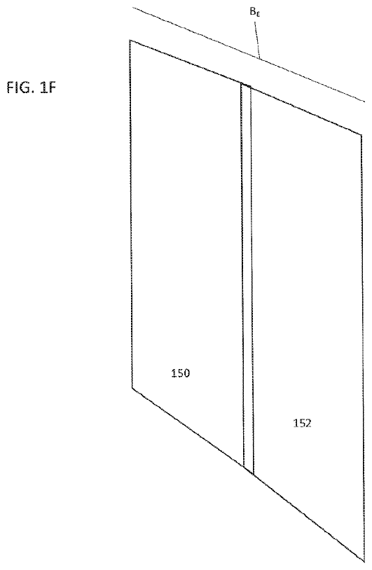

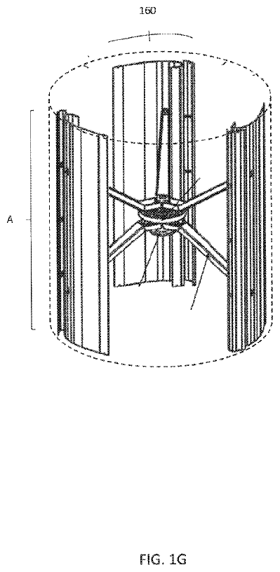

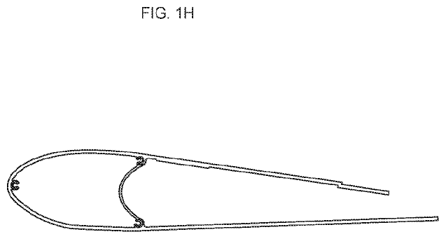

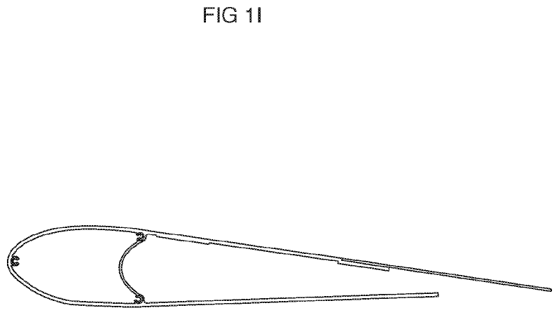

The present device, a vertically oriented blade shown generally as blade 100 in FIG. 1A, can be utilized in wind turbines normally constructed of one or more thin planar metals, such as steel or aluminum or composite materials such as fiber glass, carbon fiber, or plastic and the like. The hybrid blade includes, generally, one or more sheets (e.g., square sheet, rectangular sheet) shaped into an approximated curvilinear shaped blade. The sheet(s) comprises a top edge, a bottom edge, an outer edge, and an inner edge (in relation to a central motor/generator). The sheet can have a thickness of about 0.5-15 mm. The thickness can be uniform along a length of the sheet or can vary. The blade comprises an outer surface 101 and an inner surface 102. The blade can include a slat also having approximate generally curvilinear shape with an outer surface and an inner surface. The blade and slat embodiments can be referred to as having approximated curvilinear shape because the shape is a series of segments with an angle between them that together form the overall curvilinear shape. It is the shaped thin material that forms the blade, having no internal structure.

The segments comprise bends in between them extending from a top edge to a bottom edge of the sheet. The bends are positioned along the sheet from the outer edge to the inner edge. In some embodiments, the segments can comprise curves or very closely spaced bends (e.g., <about 1 mm), extending from a top edge to a bottom edge of the sheet. The approximately curvilinear shape forms an outer surface and an inner surface of the sheet or blade. As shown in FIG. 1A, the outer surface of the blade towards the outer edge is the leading edge 120 of the blade as that is the portion of the blade that leads during motion of the blade. The inner edge of the blade forms the trailing edge 124 of the blade as that portion follows during motion of the blade. Between the leading edge 120 and the trailing edge 124 is the midsection 122 of the blade.

The bends can be done less than 1 mm apart, effectively creating a curve surface. In some embodiments, the leading edge 120 comprises about 2-20 (e.g., 2-10, 5-15, 15-20, 20) bends. A distance between each bend can be less than about 5 mm. It will be appreciated that these values can depend on the desired size of the blade. In some embodiments, a distance between bends in the leading edge can be about 1/20- 1/30 of the width of the sheet of material used to form the blade. Larger blades may have longer bend segments. An angle between the bends can be about from 1 to 15 degrees. In some embodiments, it is about 1 to 15 degrees. In some embodiments, the leading edge comprises more bend segments than the midsection or the trailing edge of the blade. The leading edge may also comprise greater bend angles than the other sections of the blade. The leading edge may also comprise a shorter distance between bend segments than the other sections of the blade.

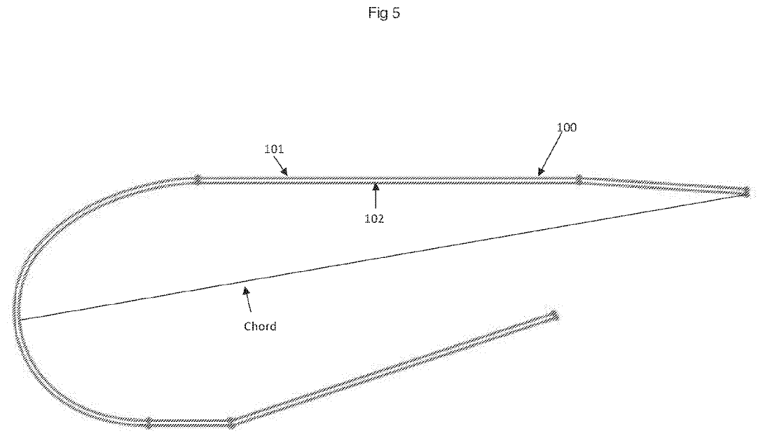

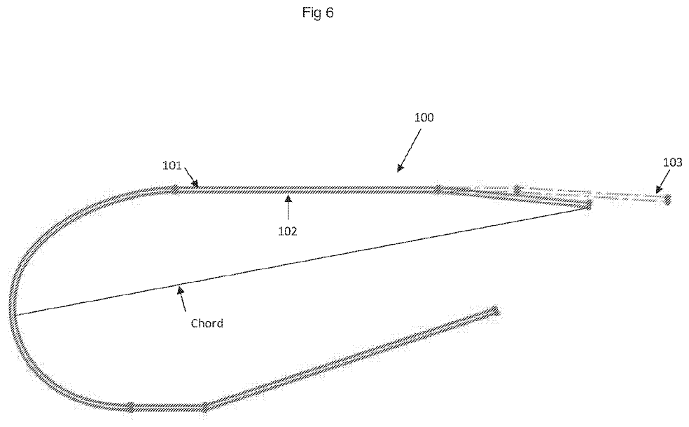

In some embodiments, the midsection 122 comprises about 4 bends. Other configurations are also possible (e.g., 1-3 bends). A distance between each bend can be less than about 1 inch (about 2.5 cm). In some embodiments, a distance between each bend in the midsection can be about 1/10 of the width of the sheet of material used to form the blade. An angle between the bends can be less than about 10 degrees. In some embodiments, an angle between the bends is about 1 to 10 degrees. In some embodiments (e.g., FIG. 1A), the midsection comprises fewer bend segments and lower bend angles than the leading edge, but more bend segments and higher bend angles than the trailing edge. In some embodiments, (e.g., FIGS. 5 and 6), the midsection comprises fewer bend segments and lower bend angles than both the leading edge and the trailing edge.

In some embodiments, the trailing edge 124 comprises less than about 3 bends (e.g., 1-3 bends). A distance between each bend can be less than about 1 inch (about 2.5 cm). In some embodiments, a distance between each bend can be about 1/10- 1/20 of the width of the sheet forming the blade. An angle between the bends can be less than about 3 degrees. In some embodiments, an angle between the bends is about 1-10 degrees. In some embodiments, (e.g., FIG. 1A, the trailing edge comprises fewer bend segments and lower bend angles than the leading edge and the midsection. In some embodiments (e.g., FIGS. 5 and 6), the trailing edge comprises fewer bend segments and lower bend angles than the leading edge, but more bend segments and higher bend angles than the leading edge.

More than 6 such bend segments are shown in the embodiments of FIGS. 1, 2, 3, and 4. More or fewer bend segments may be used depending on the design parameters. For example, 3, 4, 5, 7, 8, 9, 10, 11, 12, or more bend segments are possible.

Each bend segment can have a length of between about 2-10 cm depending on de position and the size of the blade. The length can be no greater than about 10 cm. The bend segments of the blade can be about 1/30- 1/10 a width of the sheet of material used to form the blade. In some embodiments, each bend segments has the same or similar lengths. Each bend segment can have a different length. Some bend segments can have a same length while others have different lengths.

In some embodiment, an angle between each bend segment is less than about 20 degrees. In other embodiments, the angle is about 15-20 degrees. Other angles are also possible (e.g., about 5-10 degrees, about 10-15 degrees, about 20-25 degrees, less than 5 degrees, greater than 25 degrees). In some embodiments, the angles between each of bend segments is the same.

In some embodiments, the angles between each of the bend segments, varies.

Each blade can have a length of about 30-6000 cm. In some embodiments, the length is about 1000 cm. Other lengths are also possible (e.g., 30 cm, 30-1000 cm, 1000 cm, 1000-3000 cm, 2000-4000 cm, 3000-6000 cm, etc.). In some embodiments, each blade has a length of about 30-6000 mm (e.g., about 30 mm, 30-1000 mm, 1000 mm, 1000-3000 mm, 2000-4000 mm, 3000-6000 mm).

FIG. 1C illustrates a sheet of material used to form a vertical wind turbine blade as described herein. The sheet of material has a length A and a width B. As described above, the sheet of material is bent (or curved, pressed, rolled, etc.) a number of times to form a turbine blade. FIG. 1D shows an embodiment of a blade 140 formed from the sheet of FIG. 1C. The blade comprises a leading edge, a trailing edge, and a midsection or a foil shape between the leading and trailing edges. The blade 140 comprises a height A substantially equal to length A of the sheet. The blade has a width C that is about 50-90% of the width B of the sheet. The blade has a depth D that is about 5-30% of the width B of the sheet. The finished blade (with curvilinear foil shape) can fit into a container (e.g., flat packet container) having a volume of A×C×D. The small footprint and low weight (e.g., based on lack of internal structure) of the blade can enable easy shipping and handling of the blade. In some embodiments, the ease of packing the blades can allow the blades or resulting turbines to be sold to consumers in a retail environment (e.g., available for pickup from a store).

In some embodiments, more than one sheet is used to form the blade. In such embodiments, the finished blade dimensions will be based on a sum of the dimensions of the more than one sheet. For example, as shown in FIG. 1F, an effective width BE of sheets of material 150, 152 can be a sum of the widths of the more than one sheet of material used to form the blade. In some portion, an overlapping portion of the multiple sheets does not contribute to the effective width.

FIG. 1G shows an embodiment of a vertical axis wind turbine comprising three blade with the design of the blade of FIG. 1C. As shown in FIG. 1G, the wind turbine comprises a height A. The wind turbine can fit into a cylindrical envelope having a height A and a circumference at least about 3 times the length of the arc 160 of the blade.

FIG. 1H shows a profile of another embodiment of portion of a blade 160. In some embodiments, the blade portion 160 is formed by extrusion. Unless otherwise specified, the blade portion 160 can comprise features similar to those described with respect to blade 100. The blade portion 160 can comprise a shape approximating a portion of an airfoil. A first generally straight portion 162 is connected to a second generally straight portion 164 by a curved portion 180. An angle α formed by the first and second portions 162, 164 is about 15-30°.

A curved segment 166 can be positioned between and connecting the first portion 162 and the second portion 164. This segment 166 can help to keep the blade portion 160 in the proper configuration during operation. C-connectors 168, 170, 172 can be used to connect the blade to the turbine. The blade portion 160 can comprise a thicker portion 174. The second portion 164 of the blade portion 160 can comprise a segment 176 offset from the rest of the first portion 164. This portion can be joined to a sheet to form the incomplete airfoil (FIG. 1I). The extrusion thickness can vary form 1 mm to 15 mm depending of the blade length and chord.

FIG. 1I shows the full blade 184, approximating an incomplete airfoil. The blade 184 comprises the portion 160 of FIG. 1H along with a sheet of material 192. As described with respect to blade 100, the blade comprises a outer region 189 and an inner region 190. The blade 184 comprises an upper surface 193 and a lower surface 194. The upper surface 193 extends past an edge of the lower surface 194, leaving a gap between the upper and lower surfaces 193, 194. This gap is what causes the blade 184 to comprise an incomplete airfoil shape. An outer surface of the blade towards the outer edge, between the upper and lower surfaces 193, 194 is the leading edge 186 of the blade. The inner region of an end of the upper surface 193 forms the trailing edge 188. Between the leading edge 186 and the trailing edge 188 is the midsection 187 of the blade 184. The portion of the blade 160 and the sheet 192 can comprise a metal such as a steel or aluminum. Other materials are also possible (e.g., composite materials such as fiber glass, carbon fiber, or plastic and the like). The portion 160 and the sheet 192 can comprise the same or different materials. In some embodiments, the angle of attack can range from about 2-10 degrees, depending on the blade solidity, the turbine geometry, and the wind range.

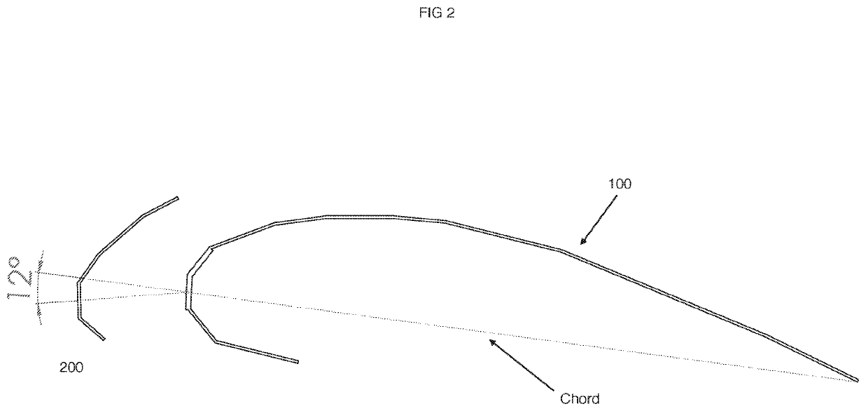

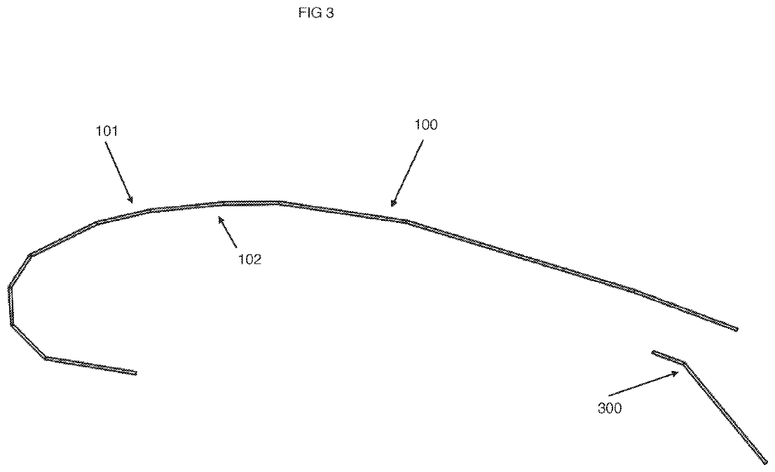

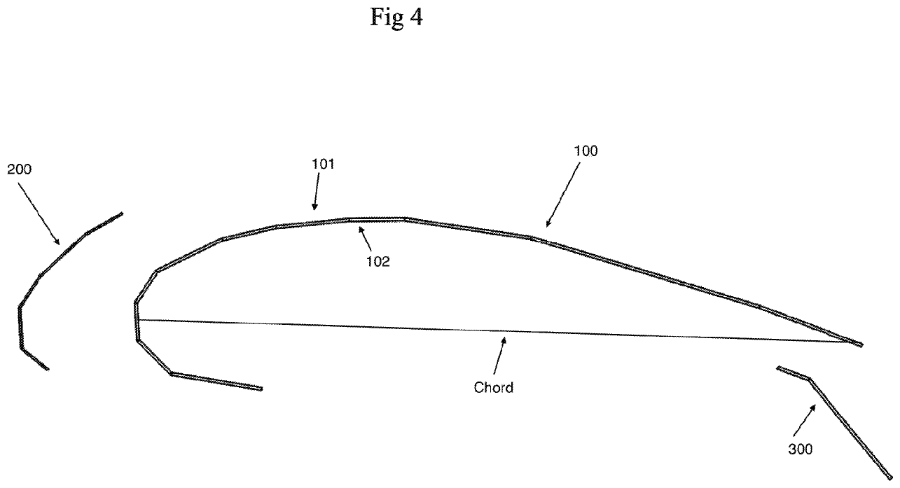

FIGS. 1A, 1I, 2, 3, and 4 illustrate profile views of different configurations of the blades 100, 184. A blade may be augmented by the addition of a slat only (FIG. 2), a flap only (FIG. 3), or both a slat and a flap (FIG. 4). Blades are made from one or more metal sheet, and undergo a metal bending process, finishing with a surface similar to an airfoil with no internal structure. That semi-airfoil shape gives a thin profile that reduces manufacturing cost and its efficiency is less than 10% lower than a smooth regular airfoil. The hybrid array of the blades 100, 184 allow the convex side of the blade (e.g. blade 100) to work as a Savonius wind turbine (e.g., as shown in U.S. Pat. No. 1,766,765A) at low wind speeds, generating torque to move the system. The concave side of the shaped thin airfoil is designed to work as a conventional vertical axis Darrieus Type wind turbine. Slats 200 and flaps 300 are aerodynamic surfaces on the leading edge and the trailing edge of an airfoil which allow the airfoil to operate at a higher angle of attack, than would be allowed without the slats or flaps. A higher coefficient of lift is produced as a result of angle of attack and speed. By incorporating a slat in proximity to the blade leading edge, and the flap on the trailing edge, the hybrid vertical blade-slat-flap turbine embodiments described herein can generate more power at lower wind speed that a conventional blade only design (e.g., a blade without a slat or a flap). Similar advantages may be achieved using the blade-slat and blade-flap configurations described herein.

FIG. 2 shows an embodiment of a blade (e.g., blade 100) and a slat 200. The slat 200 is positioned at a leading edge 210 of the blade 100. Similar to a blade 100, a slat 200 can comprise a number of bend segments. The slat 200 shown in FIG. 2 comprises five segments. Fewer or more bend segments are also possible (e.g., 3, 4, 6, 7, 8, 9, 10, or more). The slat 200 can be constructed from a sheet of the same materials as described above for the blades. It can also be constructed using an extrusion method, creating a smooth surface. In some embodiments, as shown in FIG. 2, the curve approximated by the slat 200 generally follows the curve of the blade 100. The slat 200 can be positioned at varying angles relative to the blade, as also described below. The embodiment shown in FIG. 2 comprises an angle of about 12 degrees relative to the chord 110 of the blade 100. The slat can be positioned at an angle of about 0-18 degrees relative to the leading edge of the blade.

FIG. 3 shows an embodiment of a blade (e.g., blade 100) and a flap 300. The flap 300 is positioned at a trailing edge 310 of the blade 100. The flap comprises a number of bend segments. The embodiment of FIG. 3 comprises 2 bend segments. Fewer or more bend segments are also possible (e.g., 1, 3, 4, 5, or more). The flap can be attached to an inner or outer surface of the blade to position the flap proximate to the trailing edge of the blade. The trailing edge of the flap can be directed towards or away from the trailing edge of the blade. The trailing edge of the flap can be directed towards or away from the central vertical axis of the turbine. The flap can be positioned at an angle from 3 to 20 degrees relative to the chord 110 of the blade 100.

In some embodiments, for example, as shown in the profile embodiments of FIGS. 5 and 6, the blade configuration does not conform to a standard airfoil design. In certain such embodiments, Computational Fluid Dynamics (CFD) can aid in the design. These blades 100 are designed to be use as in the other cases, with or without additional features like the slats 200 or the flaps 300. In these embodiments, the blade is bent such that the leading and trailing ends of the blade 100 are positioned within from 10 to 1000 mm of one another, depending on the scale of the blade. Such blades can comprise a central segment 620 curved in a non-symmetrical U-configuration. Such a curve can be formed, for example, using a die press in a bender machine. The inner side of the blade 102 works as a concave section to generate torque at low wind speeds, while the outer side 101 works as a conventional airfoil at higher wind speeds. In these blades, the angle of attack is about 7 degrees using the chord 110 from leading edge 210 to tail 510. Other angles of attack (e.g. from 2 to 10 degrees) are also possible. FIG. 6 also shows extension 103 in the trailing edge of the blade.

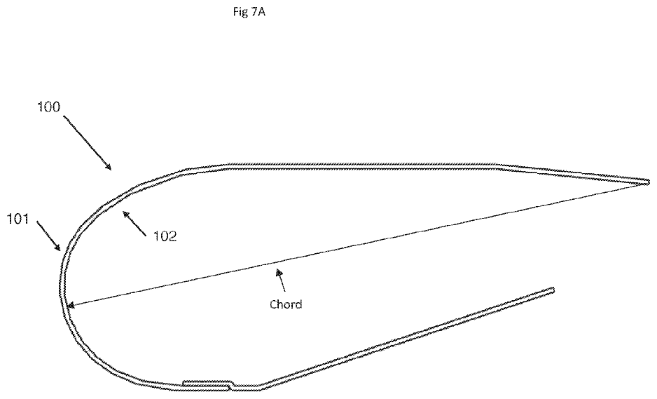

FIG. 7A shows the blade 100 from FIG. 6, using 2 sheets to complete the airfoil. This embodiment comprises the same bent sheet configuration, using, for example, welding or rivets (not shown) to connect the two sections. The step 150 provides an additional support to the connection and allows keeping the profile on the outer side 101. FIG. 7B also depicts the blade 100 from FIG. 6, but with no step on the connection between the 2 parts.

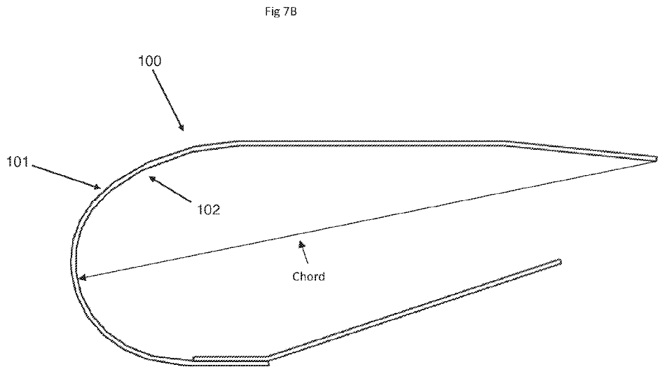

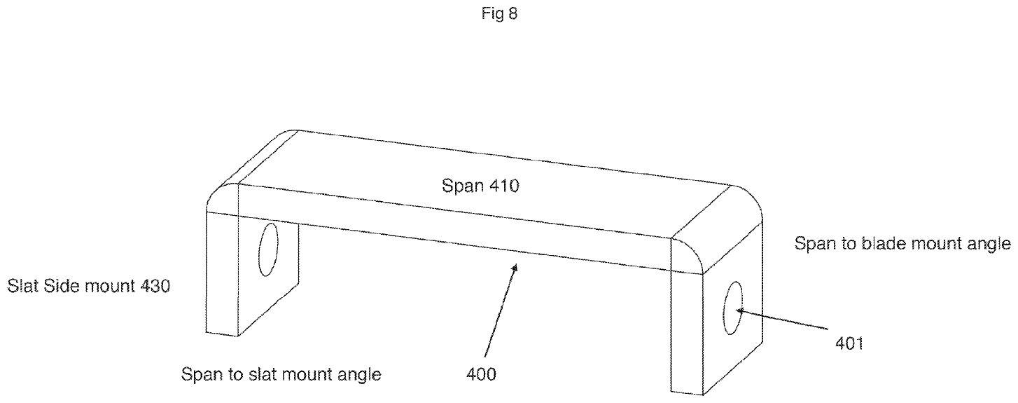

FIG. 8 shows an isometric view of an embodiment of a bridge 400 used to fix the slat 200 to a blade (e.g., the blade 100). The bridge 400 has a span 410 adapted to engage the slat with the slat side mount 430 and the blade with the blade side mount 420. The bridge 400 is also made by a bending process, making it easy and inexpensive to manufacture. The bridge can comprise the same materials as those described above with respect to the blade. The bridge can comprise a length of about 3 cm to 40 cm. FIG. 8 also illustrates an embodiment, in which the slat side mount-span angle 425 and the blade side mount-span angle 435 are each 90 degrees. Other configurations are also possible. For example, the slat side mount-span angle 425 can be between about 60 to 90 degrees. The blade side mount-span angle 435 can be about 60 to 90 degrees. Different span angles may be used depending upon the specific design characteristics of the span and the blade as well as the desired final orientation between the span and the blade. For example, FIGS. 2 and 4 present variations in the slat-blade orientation angle. The angle of the slat 200 can vary based on the desired orientation based on a number of design factors. For example, the slat-blade angle can selected from an angle of 0 degrees as in FIG. 4 to up to 12 degrees as in FIG. 2. The angle of the slat is measured with respect to the blade 100 chord, to modify the lift/drag ratio according to the wind speed to optimize power output. Apertures 401 can be used to mount the bridge 400 to the blade and the slat, for example via rivets, bolts, or the like.

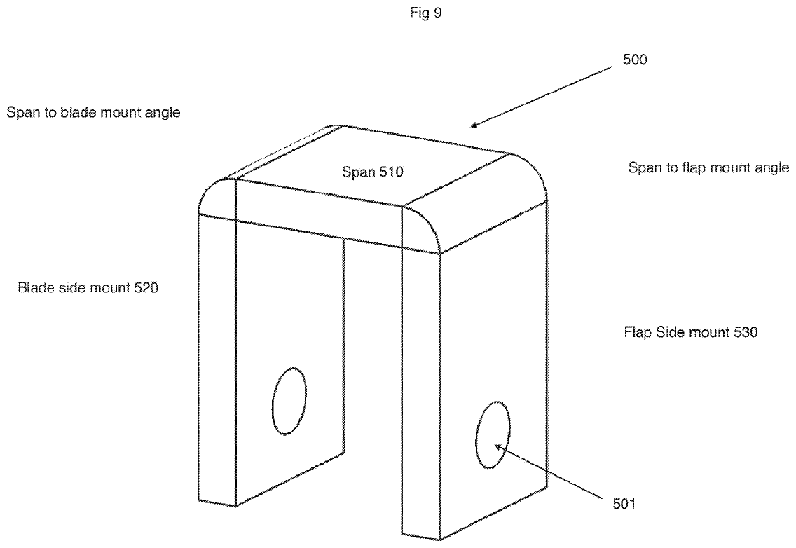

FIG. 9 is a detailed view of an embodiment of a flap mounting bridge 500, comprising a blade side mount 520 and a flap side mount 530. The bridge 500 comprises a span 510 adapted to engage a flap with the flap side mount 530 and the blade with the blade side mount 520. Bridge 500 also comprises a side mount span angle (blade to span 525, span to flap 535) of about 90 degrees. Other angles are also possible. For example, the flap side mount-span angle 535 can be about 75 to 90 degrees. The blade side mount-span angle 525 can be about 90 degrees. This part is also manufactured using sheet bending process and can comprise the same materials as described above with respect to the blade. The bridge span 510 can comprise a length of about 2 to 10 cm. The flap side mount 530 can comprise a length of about 2 to 20 cm. The blade side mount 520 can comprise a length of about 2 to 30 cm.

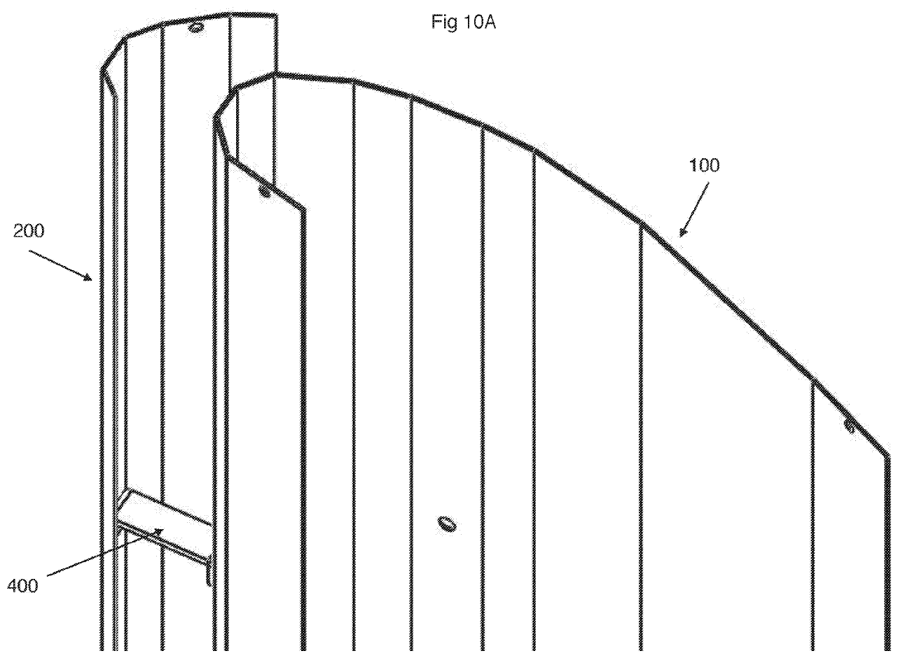

An exemplary flap mount 500 is shown in use in FIG. 11 connecting a blade (e.g., blade 100) to flap 300. As described above, the flap mount 500 may have various geometries and dimensions to adopt blade-flap configurations similar to bridge 400 to adopt blade-slat configurations. FIG. 11 shows 3 bridges 500 being used to connect the blade 100 to the flap 300. Fewer or more bridges can also be used. For example, 2, 4, 5, 6, 7, or more bridges may be used.

FIGS. 10A and 10B show an embodiment of a blade slat combination using 3 bridges 400 to connect a blade (e.g., the blade 100) to the slat 200. The bridges 400 can be fixed to the slats and blades using rivets or bolts. Fewer or more bridges can be used to connect a blade to a slat. For example, 2, 4, 5, 6, 7, or more bridges may be used. FIG. 10A shows a detailed view of the bridge connecting the slat and the blade.

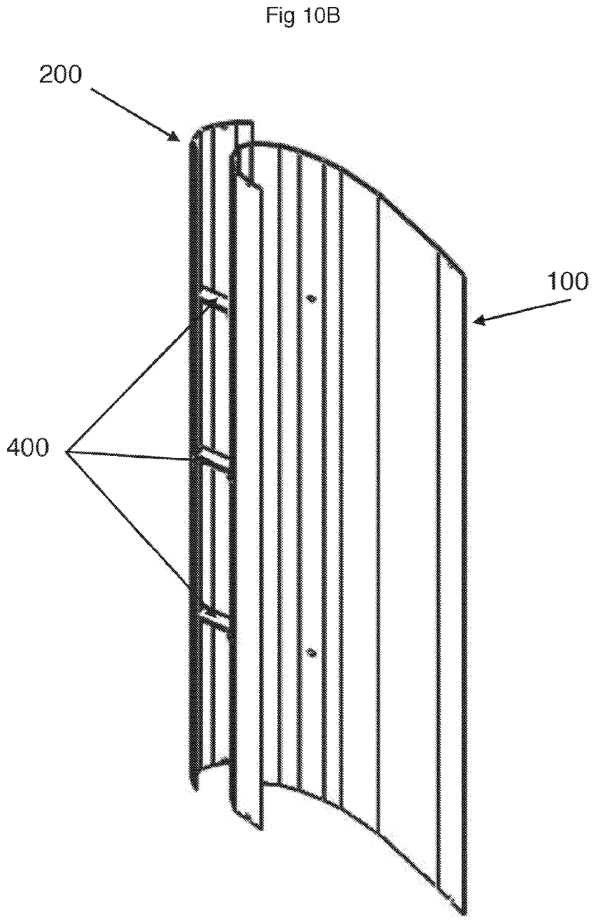

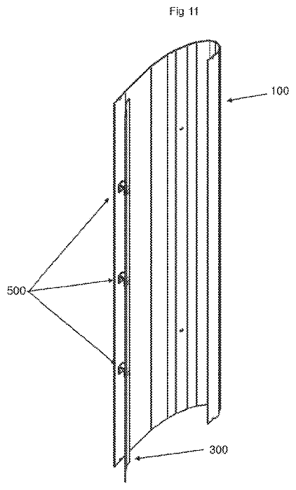

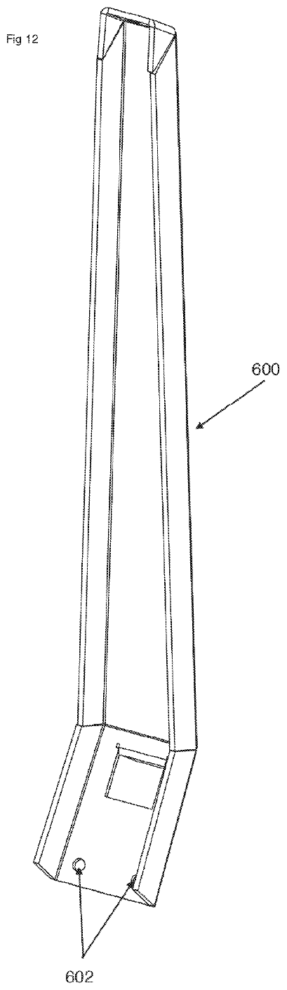

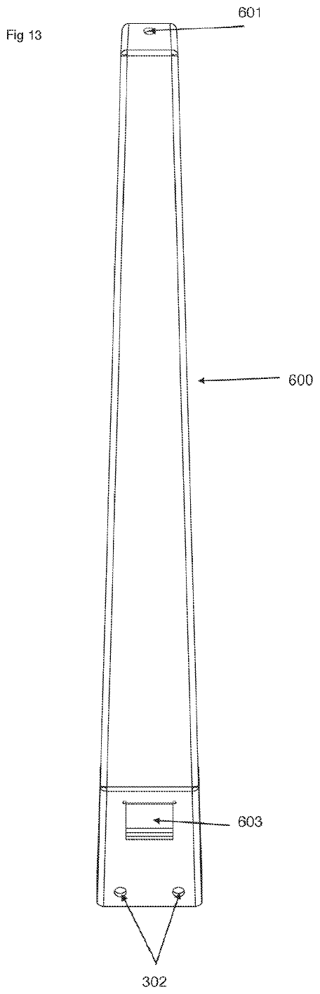

FIGS. 12-14 show different views of an embodiment of a turbine arm 600 that can be manufactured using extrusion technique and flat metal sheets. FIG. 12 shows a perspective view of an inner side of the arm 600. Apertures 601 can be used to connect a base portion 610 of the arm 600 to a generator. Base portion 610 can be configured to rest against a generator to aid in stability of the connection. Outer portion 614 can be configured to rest against a blade to aid in stability of the connection. The arm can be manufactured using the same bending process as described previously for the blades, making it easy to manufacture. Walls 612 are designed to support weight and provide structural stability to the system. FIG. 13 shows a top view of an outer side of the arm 600. A stand 603 is bent from the arm 600 and is configured to help support the blade, and provide a solid base. Aperture(s) 601 can be used to connect the arm 600 to a blade. FIG. 14 is a side view of arm 600, showing wall 612. The arm 600 can have a length from about 30 to 300 cm and have a width of about 30 to 50 cm with angles from about 15 to 45 degrees, depending on the scale and the size of the turbine. The angle of the arm is specific to each blade length, and is designed to absorb harmonic vibrations and to reduce the centrifugal force of the blade caused by the high revolutions. More or fewer apertures can be used to secure the arm to the generator or the blade.

FIG. 15A is a detailed view of an embodiment of a connection of a blade (e.g., blade 100) and an arm 600 through the hole 601 (not shown) in the arm 600 and holes in the blade 100 using a bolt and self locking nut 700. Other fixing mechanisms (e.g., rivets) are also possible. Also visible in this section view of the blade is a close up view of a bridge 400 between a blade 100 and a slat 200.

FIG. 15B is a view of an embodiment of a connection of between a blade 100 and an arm 600 (e.g., an extruded arm) using a bold and self locking nut 700. Other fixing mechanisms (e.g., rivets) are also possible.

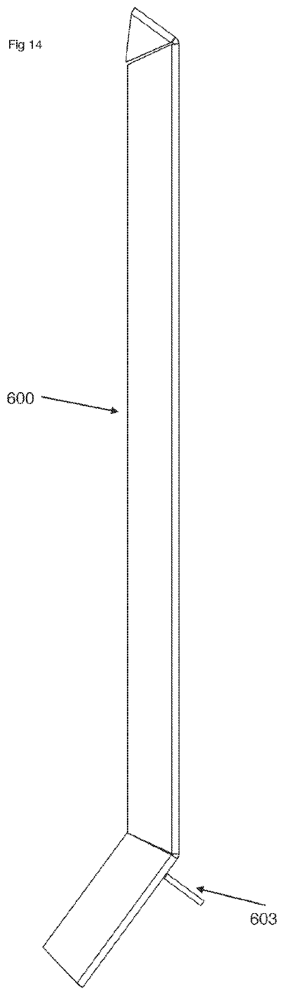

FIG. 16 is a perspective view of an embodiment of a mirror configuration of the arms 300 mounted on a blade 100 in position for coupling to a generator. The arms 300 are positioned so that they extend outward from base portions 610 toward an upper fixation point and lower fixation point on the blade 100. Outer side of the arms 300 are facing each other, while the inner side (side with walls 612) of the upper arm 1602 faces up and the inner side of the lower arm 1604 faces down.

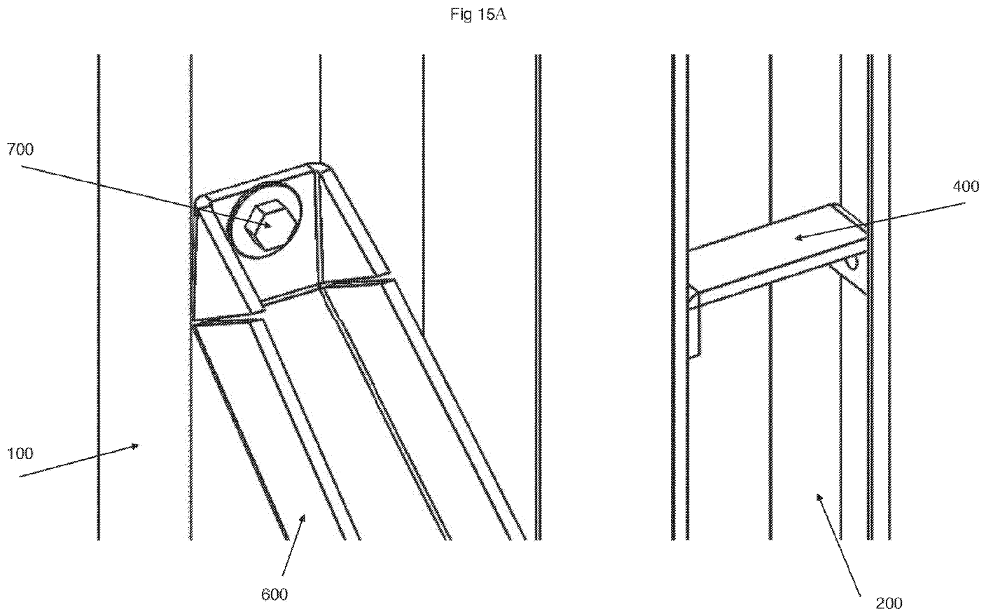

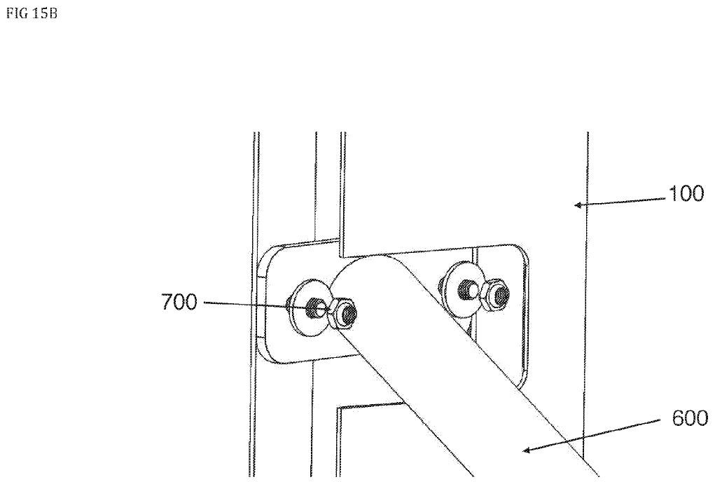

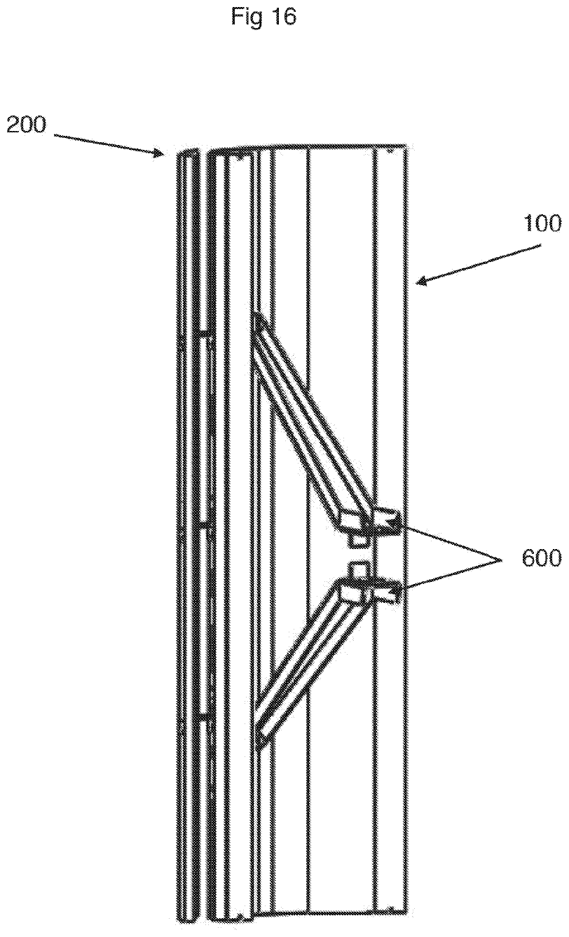

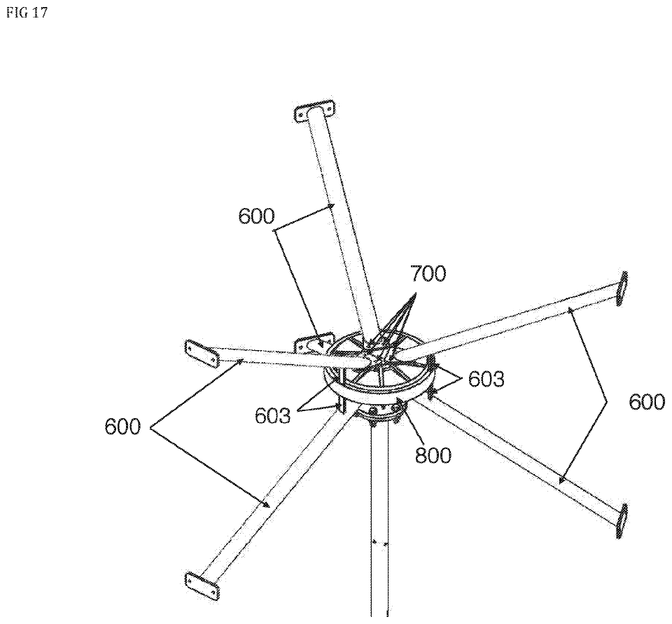

FIG. 17 shows a detailed view of an embodiment of an arm 600 mounted to a generator 800 using the arm holes 602 (not shown) and bolts 700. The stand 603 is configured to fit on the step 1702 over the generator 800. Any kind of excited or non-excited generator or alternator can be used with the system, due to their high starting torque and the possibility of reaching high RPMs. An exemplary generator is a Permanent Magnet Alternator, axial flux, and coreless. Another exemplary generator is illustrated and described in U.S. Patent Application Publication US20130049512 A1.

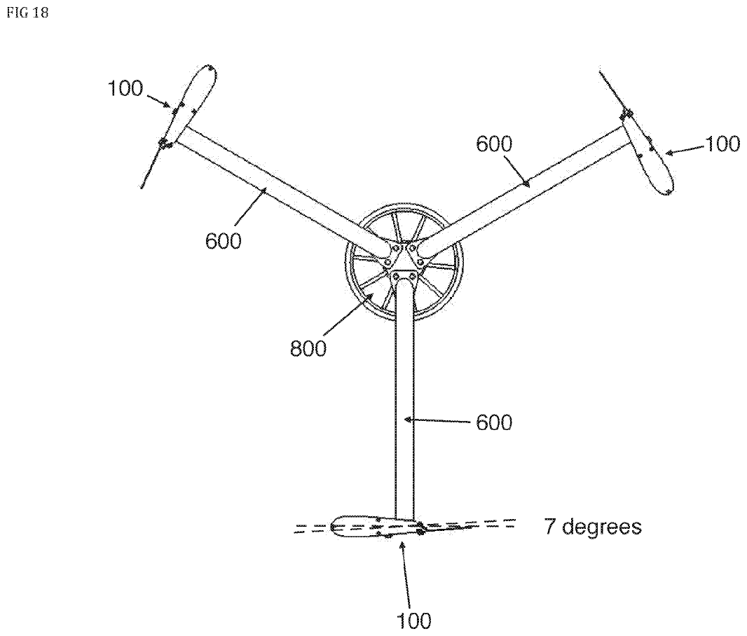

FIG. 18 shows a top down view of an embodiment of a turbine, having a 3 blade (e.g., blade 100) configuration, with one slat 200 in each blade 100 with mounting arms 600 extending from an axial flux alternator 800 in the middle. The arms 600 can be transversely oriented with respect to the central alternator or generator. The arms 600 can be mounted to a rotor shaft of the generator or alternator. The configuration illustrates the blades 100 distributed evenly in a concentric array around the alternator 800. This view also shows the attack angle 1802 of the blade group measured from the center of the arm 600 and the blade 100 chord. In some embodiments, the attack angle 1802 is about 7 degrees. Other angles are also possible (e.g., about 5-12 degrees, about 6-10 degrees, about 6-8 degrees, etc.). FIG. 19 is a perspective view of an embodiment of a turbine system, showing a base 900 of the turbine. FIG. 19 shows the mirror configuration of the arms 600 (e.g., as shown in FIG. 16) extending from an alternator 800 and the way in which the arms are connected to the blades 100 (e.g., in a manner similar to that shown in FIGS. 15 and 16).

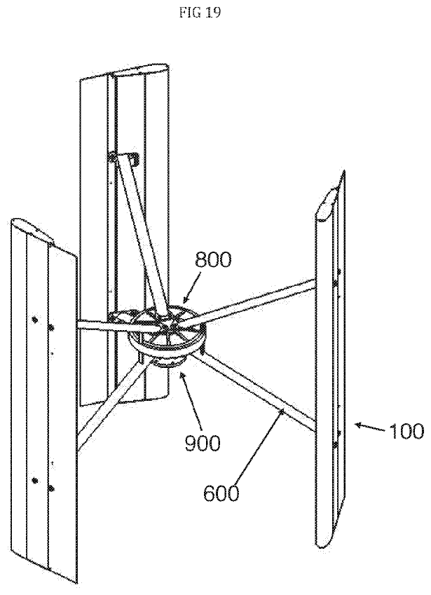

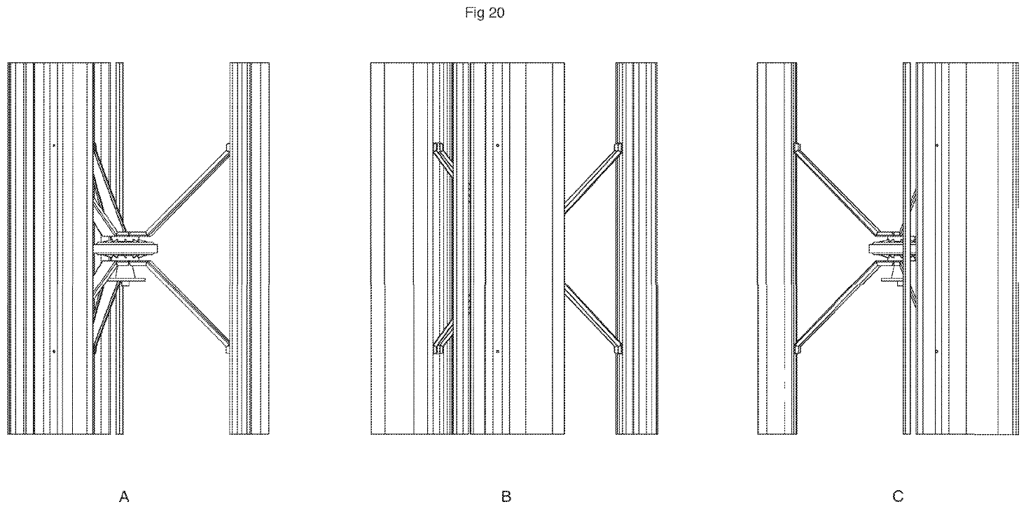

FIGS. 20A-20C show side views of the turbines of FIGS. 18 and 19 with the blades in different positions of rotation, allowing various views of the turbine.

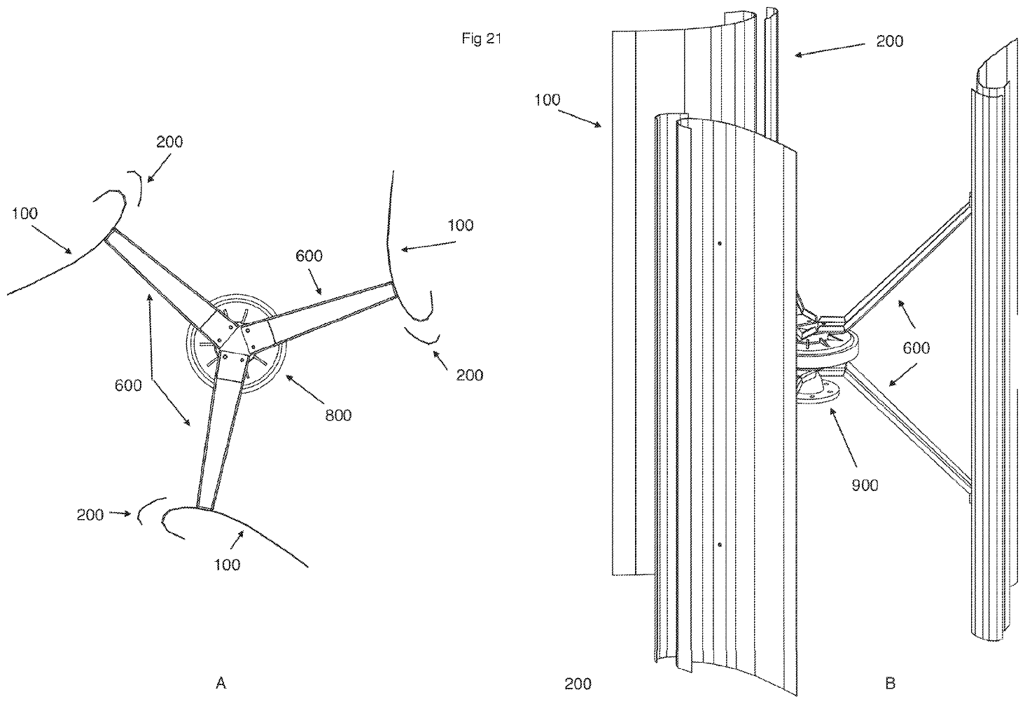

FIGS. 21A and 21B are top down and perspective views, respectively, of an alternative embodiment of a turbine configuration having outer blades (e.g., blades 100) mounted with the convex side facing to the outside of the turbine hub and a slat 200 adjacent to the leading edge 2102. The blades 100 are connected by arms 600 to a central generator 800. The perspective view of FIG. 21B shows base 900 positioned under the generator 800.

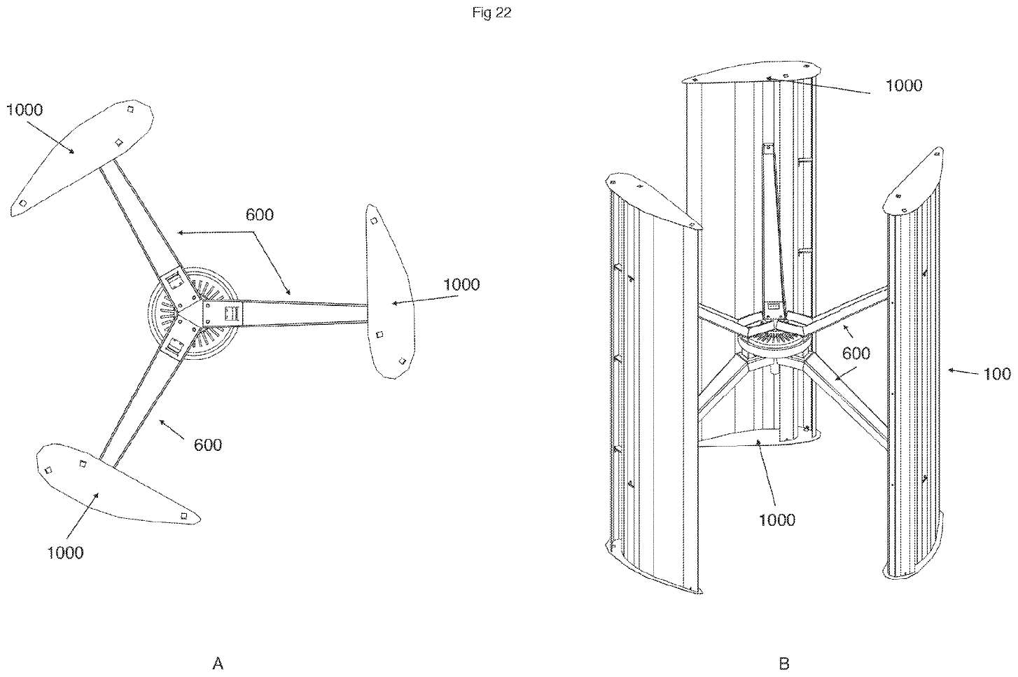

FIGS. 22A and 22B illustrate top down and perspective views, respectively, of the configuration of the blades 100 and slats 200 of FIG. 16 having winglets 1000 on the upper and lower surfaces to canalize the air flow inside the turbine and the slats 200 for increasing the power output. In other aspects, winglets are configured for other blade designs and for use with slat and flap configurations. The winglet can be attached using bolts, rivets, welding, or the like. The winglets can comprise the same materials as those described with respect to the blades. The winglets can also be positioned on only the upper surfaces or only the lower surfaces.

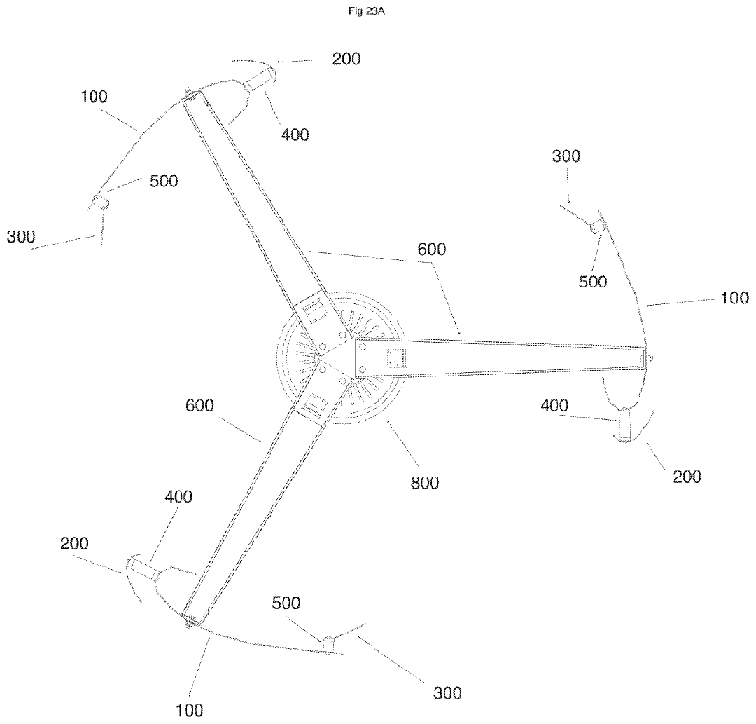

FIGS. 23A and 23B are top down and perspective views, respectively, of an embodiment of a turbine, having a 3 blade (e.g., blade 100) configuration, with one slat 200 and a flap 300 attached to each blade 100 using bridges 400, 500. Mounting arms 600 connect each blade 600 to an axial flux alternator 800 positioned in the middle. The configuration illustrates the blades 100 distributed evenly in a concentrically array around the alternator 800.

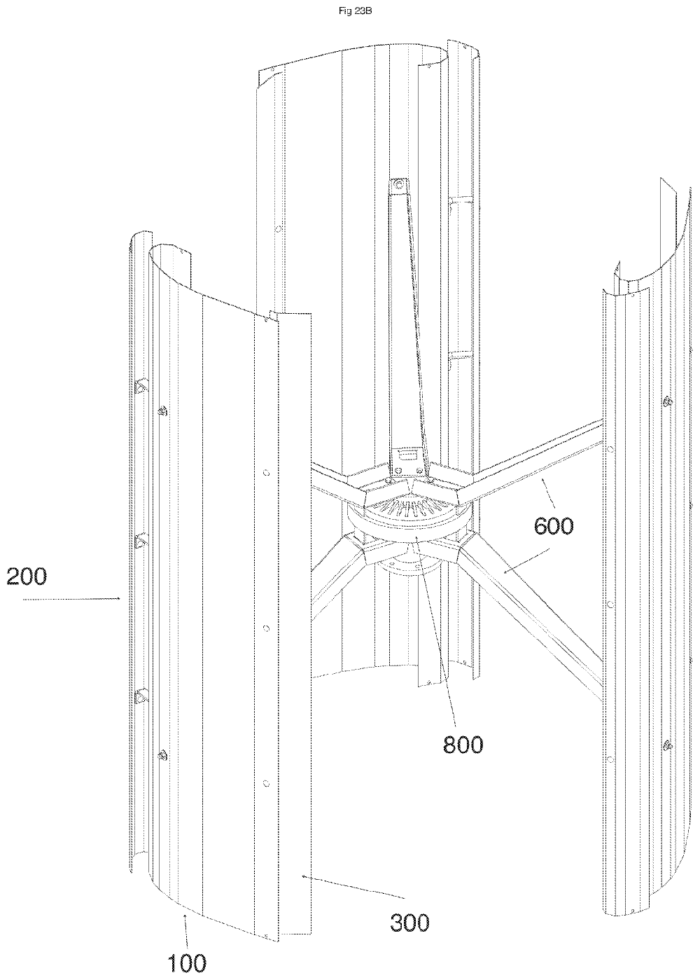

FIG. 24 is a view of a turbine, similar to that shown in FIG. 22B, comprising the winglets 1000 on the upper and lower surfaces to canalize the air flow inside the turbine. The turbine comprises slats 200 and the flaps 300 connected to blades (e.g., blades 100) for increasing the power output. Arms 500 connect blades 100 to a central generator.

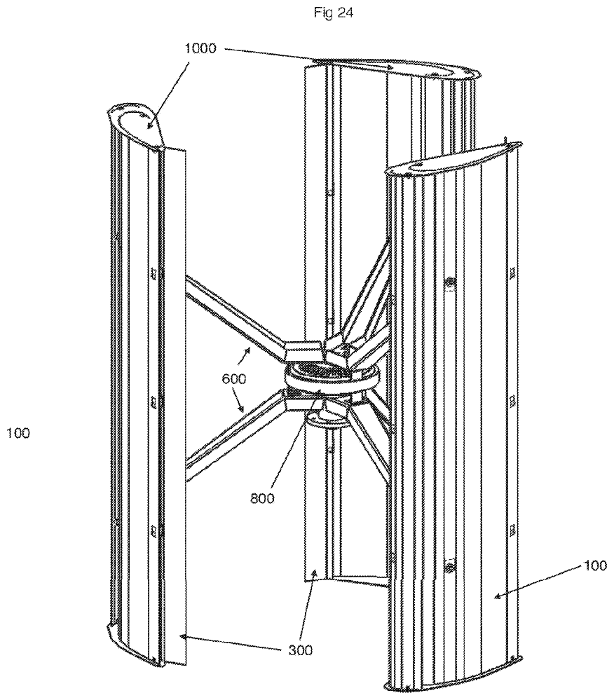

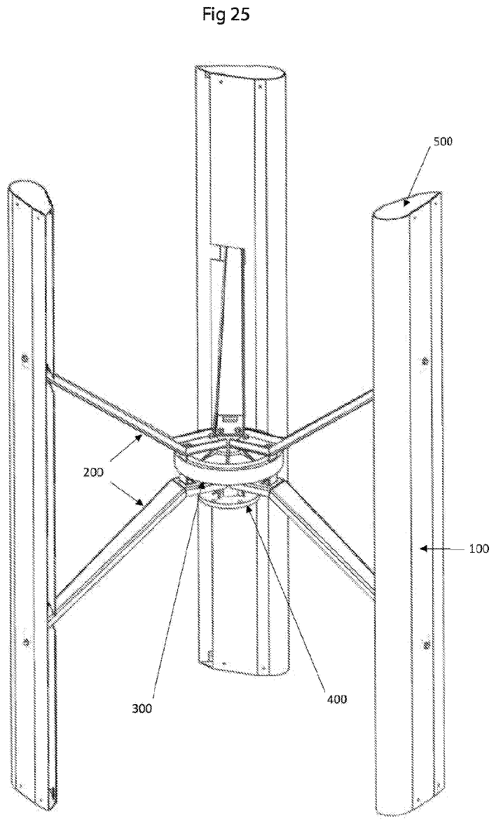

FIG. 25 is a perspective view of the complete assembly, using the blades 100 from FIG. 5. Each blade 100 comprise a winglet 1000 configured to canalize air flow inside the turbine. Arms 600 connect the blades 100 to a central generator 800 comprising base 900. As shown in FIG. 25, the blade 100 can comprise cutouts 2502 to allow for passage of the arm 600.

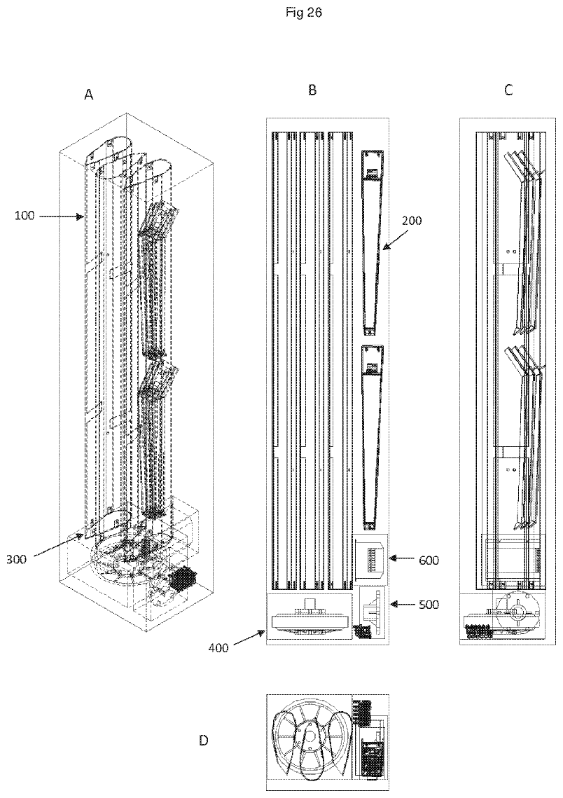

FIGS. 26A-D are schematic drawing of the turbine in FIG. 25, ready for delivering, using a flat packed array. FIG. 26A shows a perspective view of an embodiment of a container holding the blades (e.g., blades) 100 and winglets 1000. The container also includes arms 600. Generator 800 is shown positioned at the bottom of the container. FIG. 26B shows a front view of the container, showing a better view of generator 800, base 900, controller 2610. FIG. 26C shows a side view of the container. FIG. 26D shows a top view of the container.

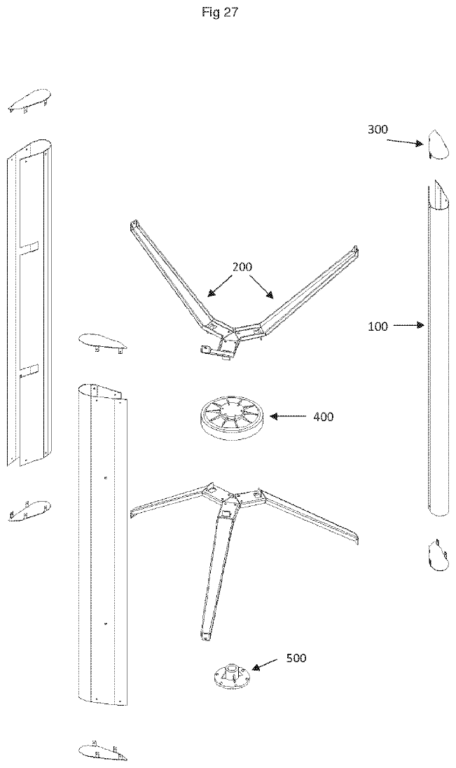

FIG. 27 is an exploded view of the turbine from Figure FIG. 25, showing all the components, including winglets 1000, blade 100, generator 800, base 900, and arms 600. Assembling the turbine can be a relatively simple process. The process can comprise simply connecting the parts using, for example, bolts and self-locking nuts. In some embodiments, the process uses only two tools. The completed assemblies shown herein comprise three blades, but more or fewer blades are also possible.

All wind turbines extract energy from the wind through aerodynamic forces. Wind can be defined as the air mass movement. This mass has the following kinetic energy:

e=½*m*v²

If this air mass goes through a circular section Aᵣ, flow value:

Q=v*Aᵣ

And its kinetic energy per volume is:

e=½*ρ*v^{2p}

The power of the wind tube, the kinetic energy flow per time:

P=½*ρ*v*Q=½*ρ*v³*Aᵣ

Using the area swept by the blade diameter:

P=c*ρ*D²*v³

This is the wind tunnel power but it is not possible to extract all of it. Wind turbines extract energy by slowing down the wind. For a wind turbine to be 100% efficient, it would need to stop 100% of the wind; but, then the rotor would have to be a solid disk and it would not turn, resulting in no kinetic energy conversion. On the other extreme, a wind turbine with just one rotor blade would cause most of the wind to pass through the area swept by the turbine blade, missing the blade completely and missing any kinetic energy transfer from the wind.

This equation shows the wind flow maximum extractable power

P=0.59*c=ρ*D²*v³

Small wind turbines are defined by IEC as a wind turbine with a rotor swept area no greater than 200 m². Therefore, the diameter is limited to 16 m. However, most of them have much smaller diameters starting at about 1 m.

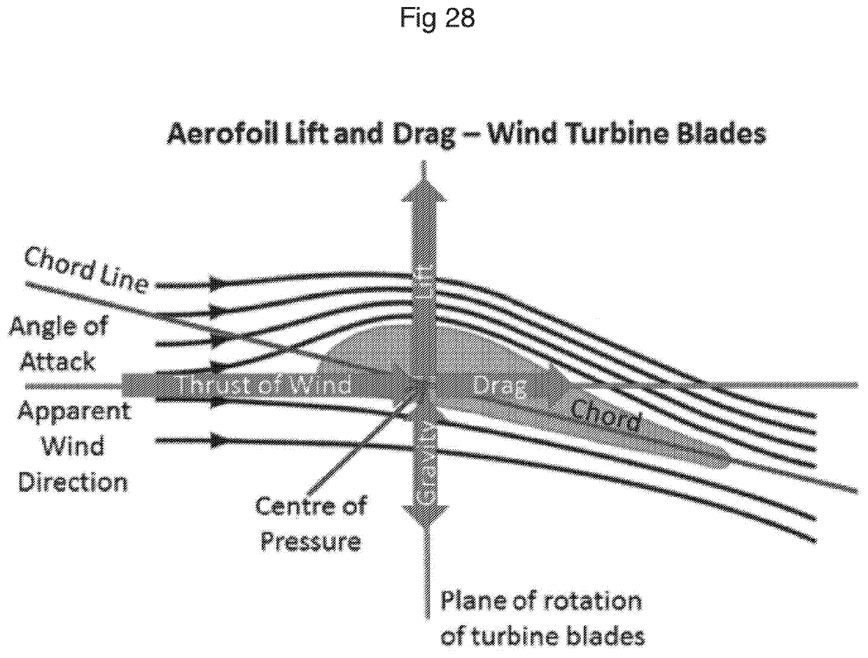

There are two important aerodynamic forces: drag and lift (see FIG. 28). The former applies a force on the body in the direction of the relative flow, while the latter applies a force perpendicular to the relative flow. Many machine topologies could be classified by the primary force used to extract the energy. For example, Darrieus (Lift Force—VAWT), Propeller type (Lift Force—HAWT) and Savonius (Drag Force—VAWT) are three different implementations of wind turbines. The Propeller type wind turbine is considered a Horizontal Axis Wind Turbine (HAWT) where the propeller rotates about a horizontal axis. The Darrieus and Savonius designs are a Vertical Axis Wind Turbine (VAWT) where they rotate about a vertical axis. Drag based machines can be conceptually simple, yet suffer from poor efficiency. Efficiency in this analysis is based on the power extracted vs. the plan-form area as explained before.

Savonius turbines can be very simple turbines. Aerodynamically, they are drag-type devices. Drag is the resistance resulting from moving a rigid surface against the wind or fluid medium. The Savonius type uses a drag force to rotate about its vertical axis. Savonius type turbines are resistant to turbulence and can be mounted closer to the ground. They also do not require shifting or rotating of the turbine in order to utilize the full potential of the wind. Compared to lift-type turbines, Savonius turbines extract less of the wind's power but usually have the advantage that they are designed to be self-starting. As of the blade arrangement of Savonius wind turbines can use a differential drag to spin, much wind energy can be lost as a constant drag resists the wind turbine movement.

The Darrieus type turbine has several attractive features. The machine rotates about a vertical axis; hence, it does not need to be turned into the wind. As a result, the Darrieus type turbine is not normally self-starting. That is, if the turbine has stopped during a period of low wind speeds, it will not usually start when the wind speed increases.

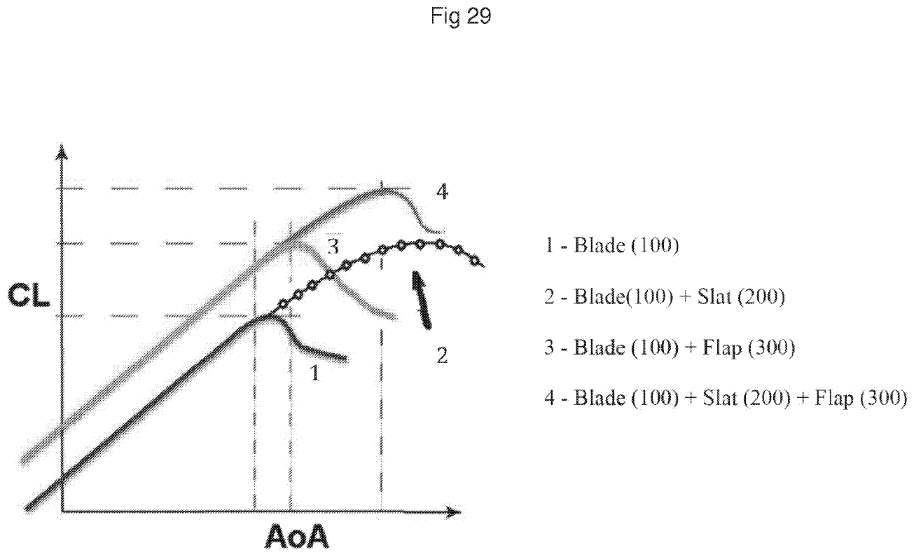

The use of a slat or a flap, or a combination, with a blade blade, as described herein, permits a single turbine to operate in a wider range of wind speeds by having the slat and/or flap to take advantage of the low wind speeds and the main blade for higher wind speeds. The size, shape and relative positions of the slat to the leading edge, the use of a flap on the trailing edge of the main blade as well as, in some embodiments, the use of the winglets to canalize the air flow. The use of the slat and flap allow the turbine to produce more power increasing the angle of attack of the blade as shown in FIG. 29 provide a suitable compromise of both lift and drag turbine capabilities.

The blade, slat and flap allowing an increased maximum lift and lift-drag ratios may be attributed primarily to the increased loading carried by the slat and the forward portion of the airfoil and to the greater pressure recovery on the upper surface of the airfoil.

The slat 200 position has a number of different possible configurations. They are predefined, at certain distance of the main blade. In some embodiments, the slat to blade arrangement is fixed such that once the slat-blade orientation is settled, then the blade-slat assembly would require partial disassembly to dismantle and change the arrangement. In other embodiments, rather than a fixed slat-blade arrangement, the slat may be held in relation to a main blade with an indexed joint that permits controlled articulation of the slat into different degrees of orientation with respect to the main blade. In this way, for example, a slat-blade orientation may be adjusted within a few degrees to accommodate for prevailing winds or, optionally, to allow different slat-blade angles to be tested upon installation in order to set the proper slat-blade relationship for the prevailing winds in a particular operation site.

In some embodiments, the position of the slat relative to the blade may vary from about 0 to 12 degrees depending on wind speed and the installation site and the use of one or both of slats and flaps to provide different blade configurations to take advantage of prevailing wind conditions at the installation site. For example, for average wind speed between 1-5 m/s a slat may be fixed at an orientation of about 12 degrees relative to the chord of the blade. In another aspect, for average wind speeds between 5 to 8 m/s, a slat may be fixed at about 6 degrees relative to the chord of the blade. In still other aspects, for average wind speeds above about 8 m/s, the slat chord is aligned to the blade chord. In still other aspects, for example, in regions where the wind speed is seasonal or varying depending on time of year, the slat can be adjusted to produce the highest output for prevailing local conditions. In a similar way, flaps may be used alone or in combination with slats to enhance performance as described herein.

In some embodiments, the turbine operates in a drag force configuration at low wind speeds (e.g., about 0.5-8 MPH) and in a lift force operation at high wind speeds (e.g., about 8-130 MPH, above about 8 MPH).

The flaps 300 are shown fixed to the blade 100 to produce high power output at low winds speeds, the flaps 300 are use in average wind conditions below 11 m/s and working with the slat, increase the productive area of the blade 100 increasing the power output of the system.

In one illustrative concept, the hybrid blade design couples using leading design with traditional construction methods, for example sheet (e.g., metal sheet) bending or shaping a sheet with multiple bends to get the predefined airfoil parameters. The method can be relatively simple. Bending of sheet is a common and vital process in manufacturing industry. Sheet metal bending is the plastic deformation of the work over an axis, creating a change in the part's geometry. Similar to other sheets forming processes, bending changes the shape of the work piece, while the volume of material remains the same. In some embodiments, some portion of or all the arms 600 that unite the blades with the generator 800, the slat 200, the flaps 300 and the bridges 400 & 500 are also manufactured with sheet bending techniques. In some embodiments, the bending process can comprise curving the sheet of material. For example, a die can be added to a bender to produce a curve in a sheet of material. For example, in some embodiments, a die is used to the shape of all or a portion of the leading edge portion, the central portion or the trailing edge portion. In such embodiments, all or a portion of the blade is produced by one or more pressing or stamping processes. Others manufacturing processes can be use to achieve the same result, like 3D printing, extrusion or rolling.

Also, arms and blades can be produced with different manufacturing methods such as extrusion and 3D printing, for example.

The process of aluminum extrusion consists of designing and creating the shape of the die, a cylindrical billet of aluminum alloy is heated to 800° F.-925° F. The aluminum billet is then transferred to a loader, where a lubricant is added to prevent it from sticking to the extrusion machine, the ram or the handle. Substantial pressure is applied to a dummy block using a ram, which pushes the aluminum billet into the container, forcing it through the die. To avoid the formation of oxides, nitrogen in liquid or gaseous form is introduced and allowed to flow through the sections of the die. This creates an inert atmosphere and increases the life of the die. The extruded part passes onto a run-out table as an elongated piece that is now the same shape as the die opening. It is then pulled to the cooling table where fans cool the newly created aluminum extrusion. When the cooling is completed, the extruded aluminum is moved to a stretcher, for straightening and work hardening. The hardened extrusions are brought to the saw table and cut according to the required lengths. The final step is to treat the extrusions with heat in age ovens, which hardens the aluminum by speeding the aging process.

The last method, 3D printing or additive manufacturing is a process of making three dimensional solid objects from a digital file. The creation of a 3D printed object is achieved using additive processes. In an additive process, an object is created by laying down successive layers of material until the entire object is created. Each of these layers can be seen as a thinly sliced horizontal cross-section of the eventual object. This last method is useful to reach many places in the world; they only need the 3D file to start manufacturing.

A generator type can be selected based on the wind power to be extracted. This generator can be self-excited or permanent magnets, synchronous or asynchronous. A self-excited shunt generator or a permanent magnet generator (PMG) that does not need an external power source to excite the motor at startup. Another consideration for the generator type was whether to build a radial flux, or axial flux PMG. The radial flux would have required many concentric cylindrical parts, a cylindrical casing, cylindrical magnets, rotor etc. In an axial flux generator, the rotor is a flat disk of magnets, which rotates on a shaft above a flat ring of stator coils. In analyzing the two design types, an axial flux PMG was chosen as our final design choice for reasons of simplicity, ease of manufacturing and cost of materials. The advantageous slat-blade turbine may also be used with suitably configured other generator types as well.

As described above, in an axial flux PMG, there is a rotor mounted with a ring of magnets. The rotor is connected to the generator shaft, which is driven, in this case, by the turbine. The magnets on the rotor are arranged so that alternating north and south poles are perpendicular to the rotor's flat top and bottom faces. The rotation of the rotor causes an alternating magnetic field at a given point above or below the rotor. The alternating magnetic field from the rotor induces a voltage in the coils of the stator. The higher the number of turns in the coils, the higher the voltage that will be induced. Also, the closer the magnets are to the coils, the higher the voltage that will be induced. Finally, the faster the rotor spins, the faster the magnetic fields are switched, the higher the voltage that will be induced. Voltage is a function of speed, while current is a function of torque.

Solidity is usually defined as the percentage of the circumference of the rotor which contains material rather than air. High-solidity machines carry a lot of material and have coarse blade angles.

Solidity,

$$σ = \frac{N \times A}{{ R}^{2}}$$

Where N is blade number, C is blade chord (m), R is wind turbine radius (m).

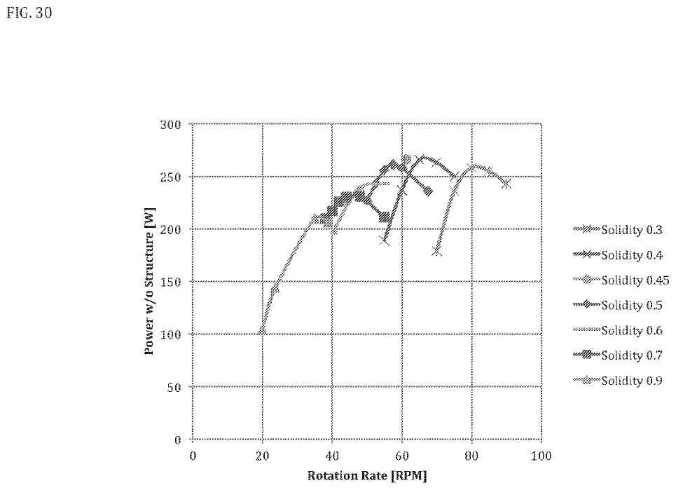

It is clear that solidity can be altered by changing either the turbine radius to blade chord ratio or by changing the number of blades. Here, we prefer to alter the solidity by changing the number of turbine blades. FIG. 30 shows the effect of different solidities in the turbine output. In some embodiments, the blade solidity can vary from about 0.2-1 depending on the geometry of the turbine.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), −/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A blade for use as in a wind turbine comprising:
a cross-sectional shape comprising a portion of an airfoil, the airfoil having an upper surface that extends past the lower surface, creating a gap between the upper and lower surfaces,
wherein the blade comprises a leading edge comprising a curved portion of the blade positioned away from an end of the upper and lower surface, and a trailing edge comprising an inner portion of an end of the upper surface.

2. The blade of claim 1, wherein the blade comprises an extruded curved section and a second section.

3. The blade of claim 1, wherein an angle of attack of the blade is about 2-10 degrees.

4. The blade of claim 1, wherein an angle between the upper surface and the lower surface is about 15-30°.

5. The blade of any of claims 1-4, wherein the length from a top edge to a bottom edge is about 30 cm to about 6000 cm.

6. The blade of claim 1, wherein the leading edge of the blade is curved towards the center of the turbine.

7. The blade of any of claims 1-6, further comprising a rectangular shaped slat shaped into a curve and mounted to place the slat proximate to a leading edge of the blade.

8. The blade of claim 7, wherein an angle between the slat and the blade is about 0-12 degrees.

9. The blade of claim 7 or 8, wherein the slat comprises a sheet with at least three bends.

10. The blade of any of claims 1-9, further comprising a rectangular shaped flap mounted at a trailing edge of the blade.

11. The blade of any of claims 1-10, wherein the blade comprises at least one of steel, aluminum, carbon fiber, fiber glass, or plastic.

12. The blade of any of claims 1-11 further comprising a winglet along an upper edge of the blade and extending from the trailing edge to the leading edge.

13. The airfoil of any of claims 1-12, further comprising a lower winglet along a lower edge of the blade and extending from the trailing edge to the leading edge.

14. A wind turbine including at least one turbine blade as claimed in any of claims 1-13 mounted to a vertical rotor shaft with at least one transversely oriented strut such that an approximately curvilinear portion proximate to the outer edge defines the outer diameter of the turbine and the blade revolves about the rotor shaft.

15. The wind turbine of claim 14, wherein the rotor shaft is connected to a generator.

16. The wind turbine of claim 15, wherein the generator is a radial flux generator or an axial flux generator.

17. The blade of any of the above claims, further comprising one or more curves extending from the top edge to the bottom edge.

18. A wind turbine including at least one turbine blade as claimed in any of claims 1-14 mounted to a vertical rotor shaft with at least one transversely oriented strut such that the leading edge defines the outer diameter of the turbine and the blade revolves about the rotor shaft.

19. A wind turbine including the blade of any of the above claims having a solidity of about 0.2-1.

20. A wind turbine including the wind turbine blade of any of the above claims having three blades and slats arranged about a central vertical axis wherein each of the slats are arranged relative to each of the blades to provide a vertical turbine that generates power using drag force operation in a first range of wind speeds and generates power using lift force operation in a second range of wind speeds.

21. The wind turbine of claim 20 wherein the first range of wind speeds is about 0.5 MPH (0.22 m/s) to about 8 MPH (3.6 m/s).

22. The wind turbine of claim 20 or 21 wherein the second range of wind speeds is about 8 MPH (3.6 m/s) to about 130 MPH (58.1 m/s).

23. The wind turbine blade of any of the above claims, wherein a length of the blade from an upper edge to the lower edge is from about 15 inches (0.4 m) to about 20 feet (6.1 m).

24. The wind turbine blade of any of the above claims wherein the blade has a thickness of about 0.5 mm to 15 mm.

25. The wind turbine blade of any of the above claims further comprising a flap attached to a blade inner surface or a blade outer surface to position the flap in relation to the trailing edge of the blade, the flap comprising a leading edge and a trailing edge.

26. The wind turbine blade of claim 25, wherein the flap trailing edge is directed towards or away from the trailing edge of the blade.

27. A method for producing a wind turbine blade comprising a blade of any of the above claims, comprising extruding a portion of the blade comprising the leading edge of the blade and attaching the portion to a sheet of material comprising the trailing edge of the blade.

28. The method of claim 27, further comprising assembling the vertical wind turbine blade with other components to form a vertical wind turbine.

29. The method of claim 28, wherein the assembling comprises connecting the components.

30. The wind turbine of any of the above claims, wherein an angle between the arms and the turbine middle horizontal point is between 15 to 35 degrees.
